(19) United States
(12) Patent Application Publication
(10) Pub. No.: US 2013/0078532 A1
(43) Pub. Date: Mar. 28, 2013

(54) NON-AQUEOUS ELECTROLYTES FOR LITHIUM ION BATTERIES

(71) Applicants: Zonghai Chen, Bolingbrook, IL (US); Khalil Amine, Oak Brook, IL (US)

(72) Inventors: Zonghai Chen, Bolingbrook, IL (US); Khalil Amine, Oak Brook, IL (US)

(21) Appl. No.: 13/246,218

(22) Filed: Sep. 27, 2011

(51) Int. Cl. H01M 10/26

(52) U.S. Cl. 429/342; 429/207; 429/340; 429/344

(57) ABSTRACT

An electrolyte includes a lithium salt; a polar aprotic solvent; a primary redox shuttle; and a lithium borate cluster salt. The lithium borate cluster salt may be compound of formula Li₂B₁₂X₁₂₋ₙHₙ, LiₓX₁₀₋ₙHₙ, where X is F, Cl, Br, or I; and n is an integer ranging from 0 to 12, inclusive.

### GOVERNMENT INTERESTS

The United States Government has rights in this invention pursuant to Contract No. DE-AC02-06CH11357 between the United States Government and UChicago Argonne, LLC, representing Argonne National Laboratory.

### FIELD

The present technology relates in general to the field of lithium-ion rechargeable batteries, and more particularly relates to the anion receptors as additives of non-aqueous electrolyte for lithium-ion batteries.

### BACKGROUND

Lithium-ion batteries have been widely used to power portable electronic devices and they also have been demonstrated promise for large-scale applications, such as hybrid electric vehicles (HEV) and stationary energy backup systems. When a lithium-ion cell is fully charged, the positive electrode contains a strong oxidizing transition metal oxide (i.e. LiMO₂, M=Ni, Co, Mn), while the negative electrode contains lithiated carbon, a very strong reducing material. Sandwiched between the positive electrode and the negative electrode is a non-aqueous electrolyte that uses an organic carbonate solvent and a lithium salt. In the cell, this solvent tends to be readily oxidized and reduced. Thus, the lithium-ion cell itself is thermodynamically unstable and the compatibility of the cell components is kinetically achieved with the presence of the surface passivation films on the electrode surface. Therefore, lithium-ion batteries are very sensitive to thermal and overcharge abuse and pose significant fire hazards. Overcharge of lithium-ion cells can lead to chemical and electrochemical reactions between battery components, gas release, and rapid increase of cell temperature. It can also trigger self-accelerating reactions in the batteries, which can lead to thermal runaway and possible explosion.

### SUMMARY

In one aspect, an electrolyte is provided including a lithium salt; a polar aprotic solvent; a primary redox shuttle; and a lithium borate cluster salt. In some embodiments, the lithium borate cluster salt is a compound of formula U₂B₁₂X₁₂₋ₙHₙ, LiₓX₁₀₋ₓHₙ, or a mixture of two or more thereof, wherein X is F, Cl, Br, or I; and n is an integer ranging from 0 to 12, inclusive. In some embodiments, the primary redox shuttle comprises a compound represented by general Formula IA, IB, or IC:

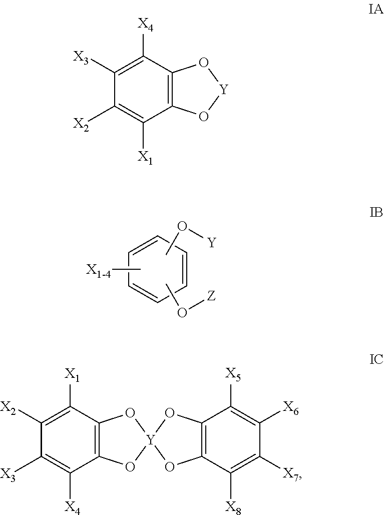

wherein X₁₋₈ are each independently H, F, Cl, Br, alkyl, alkoxyl, haloalkyl, CN, or NO₂; and Y and Z are independently a group having a N, B, C, Si, S, or P atom, wherein the N, B, C, Si, S, or P atom is attached to at least one of the two or more oxygen atoms bonded to the aromatic ring. In some such embodiments, the redox shuttle includes a compound represented by Formula IA:

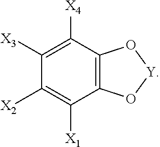

In some embodiments, the compound represented by Formula IA is a compound of Formula:

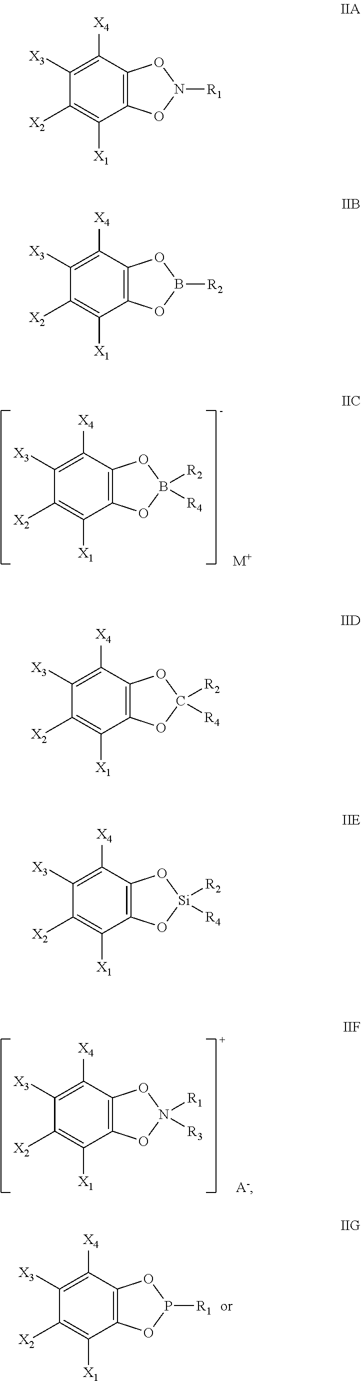

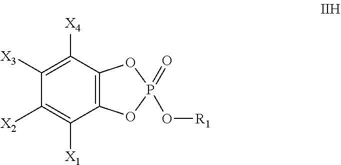

wherein each R₁ and R₃ is independently H, halogen, an alkyl group, an aryl group, a halogen substituted alkyl group, or a halogen substituted aryl group; each R₂ and R₄ is independently a halogen atom, an alkyl group, an aryl group, a halogen substituted alkyl group, or a halogen substituted aryl group; M⁺ is an alkali metal cation; and A⁻ is an anion. In some embodiments, the compound represented by Formula IA is a compound of Formula IIB, each X₁₋₄ is F, Cl, Br, or I; and R₁ is a halogen substituted aryl group. In any of the above electrolytes, the primary redox shuttle may be (tetrafluorobenzo-1,2-dioxyl)-pentafluorophenyl-borane, 1,2-bis(trimethylsiloxyl)tetrafluorobenzene, or a mixture thereof.

In some embodiments, in any of the above electrolytes, the polar aprotic solvent includes a silane, a siloxane, a organic phosphate, ethylene carbonate, propylene carbonate, dimethyl carbonate, diethyl carbonate, ethyl methyl carbonate, dimethyl ether, or γ-butyrolactone.

In some embodiments, in any of the above electrolytes, the lithium salt includes Li[B(C₂O₄)₂]; Li[BF₂(C₂O₄)]; LiClO₄; LiBF₄; LiAsF₆; LiSbF₆; LiBr, LiPF₆; LiPF₂(C₂O₄)₂; LiPF₄(C₂O₄); Li[CF₃SO₃]; Li[N(CF₃SO₂)₂]; Li[C(CF₃SO₂)₃]; Li[B(C₆F₅)₄]; Li[B(C₆H₅)₄]; Li[N(SO₂CF₃)₂]; Li[N(SO₂CF₂CF₃)₂]; LiN(SO₂C₂F₅)₂; Li[BF₃C₂F₅]; Li[PF₃(CF₂CF₃)₃]; an lithium alkyl fluorophosphate; or a mixture of any two or more thereof. However, in some embodments, the lithium salt is LiClO₄; LiBF₄; LiAsF₆; LiSbF₆; LiBr, LiPF₆; Li[CF₃SO₃]; Li[N(CF₃SO₂)₂]; Li[C(CF₃SO₂)₃]; Li[B(C₆F₅)₄]; Li[B(C₆H₅)₄]; Li[N(SO₂CF₃)₂]; Li[N(SO₂CF₂CF₃)₂]; LiN(SO₂C₂F₅)₂; Li[BF₃C₂F₅]; Li[PF₃(CF₂CF₃)₃]; an lithium alkyl fluorophosphate; or a mixture of any two or more thereof; and the electrolyte further comprises about 0.001 to about 8 wt % of Li[(C₂O₄)₂B], Li(C₂O₄)BF₂, LiPF₂(C₂O₄)₂, LiPF₄(C₂O₄), or a mixture of any two or more thereof.

In another aspect, an electrochemical device includes a cathode; an anode; and an electrolyte, the electrolyte being any of the electrolytes described above. In some embodiments, the electrochemical device is a lithium secondary battery; the cathode is a lithium metal oxide cathode; the anode is a carbon or lithium metal anode; and the anode and cathode are separated from each other by a porous separator.

### BRIEF DESCRIPTION OF THE DRAWINGS

FIG. 1 is a charge/discharge capacity graph of a LiNi_{0.8}Co_{0.15}Al_{0.05}O₂/C lithium ion cell using an electrolyte having 2-(pentafluorophenyl)-tetrafluoro-1,3,2-benzodioxaborole, according to the examples.

FIG. 2 is a charge/discharge capacity graph of a Li_{1.1}[Mn_{1/3}Ni_{1/3}Co_{1/3}]_{0.9}O₂/C lithium ion cell during the overcharge test using Li₂B₁₂F₉H₃ based electrolyte, according to the examples.

FIG. 3 is a charge/discharge capacity graph of a Li_{1.1}[Mn_{1/3}Ni_{1/3}Co_{1/3}]_{0.9}O₂/C lithium ion cell during the overcharge test using Li₂B₁₂F₉H₃ based electrolyte containing 5 wt % 2-(pentafluorophenyl)-tetrafluoro-1,3,2-benzodioxaborole, according to the examples.

### DETAILED DESCRIPTION

The present invention relates to non-aqueous electrolytes for lithium-ion batteries. Electrolytes of the present invention use a combination of at least two types of the redox shuttles to improve the overcharge tolerance of lithium ion cells. The primary redox shuttle of the present invention is lithium borate cluster salts, and the secondary redox shuttle is an aromatic redox shuttle. Accordingly, the invention provides non-aqueous electrolytes, methods of making such electrolytes and electrochemical devices using inventive electrolytes.

The present invention relates to electrolytes containing lithium borate cluster salts and an aromatic redox shuttle to improve the overcharge tolerance of lithium-ion batteries. In accordance with one aspect of the present invention, there are provided electrolytes that include a lithium salt; a polar aprotic solvent; a primary redox shuttle; and a secondary redox shuttle. The primary redox shuttle is a lithium borate cluster salt, and the secondary redox shuttle is an aromatic redox shuttle. In accordance with another aspect of the present invention, there are provided electrolytes that include a lithium borate cluster salt; a polar aprotic solvent; and an aromatic redox shuttle.

In accordance with some aspects of the present invention, the lithium borate cluster salts has a formula of, but not limited to, Li₂B₁₂X₁₂₋ₙHₙ or Li₂B₁₀X₁₀₋ₙHₙ wherein X is a halogen and n is an integer ranging from 0 to 12. In some embodiments, the lithium borate cluster salt of the present invention has a characteristic redox potential at above 4.0 V vs. Li⁺/Li, and its redox reaction is highly reversible.

In accordance with an aspect of the present invention, the aromatic redox shuttle of the present invention include for example, compounds having Formula IA, IB, or IC:

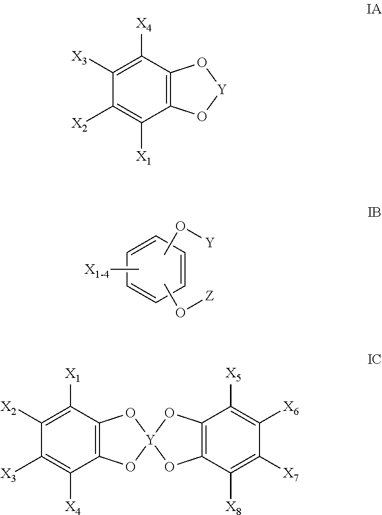

wherein X₁₋₈ are each independently selected from —H, —F, —Cl, —Br, alkyl, aryl, alkenyl, haloalkyl, —CN, or —NO₂; and Y and Z are independently a group having a N, B, C, Si, S, or P atom, where the N, B, C, Si, S, or P atom is attached to at least one of the two or more oxygen atoms bonded to the aromatic ring, as shown in structures IA, IB, and IC. Y and Z may individually be a terminal group or a bridging group.

In some embodiments, the redox shuttle has the Formula IA. Exemplary compounds having the Formula IA include the following structures:

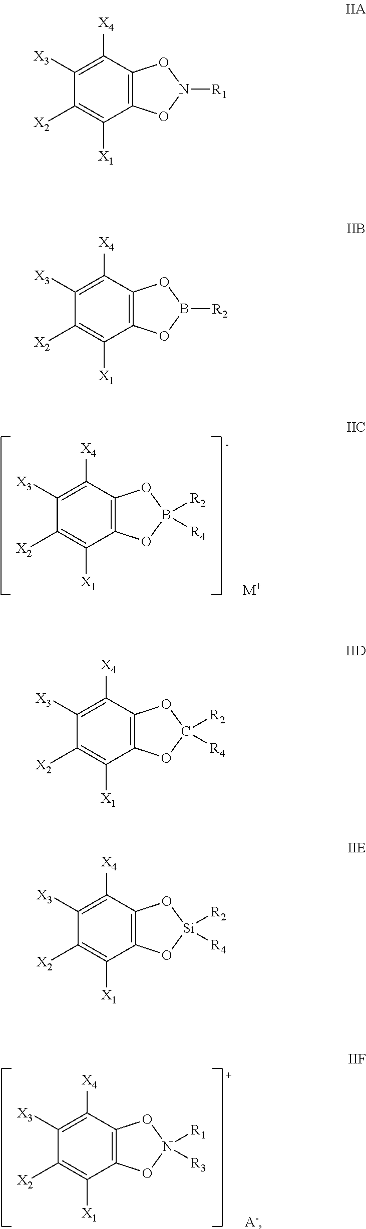

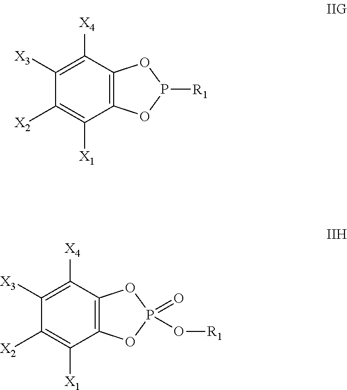

wherein each R₁ and R₃ is independently a hydrogen, halogen, an alkyl group, an aryl group, a halogen substituted alkyl group, or a halogen substituted aryl group; each R₂ and R₄ is independently a halogen atom, an alkyl group, an aryl group, a halogen substituted alkyl group, or a halogen substituted aryl group; M⁺ is cation; and A⁻ is an anion. M⁺ is typically an alkali metal cation such as Li⁺, while A⁻ is typically a halide, though the invention is not so limited. Representative compounds of the invention are either commercially available or may be synthesized by known methods. Thus, for example, IIB may be prepared by slight modification of the procedures reported in Lee, et al., J. Electrochem. Soc. 152(9): A1429-35 (2004).

As will be appreciated by those of skill in the art, certain compounds such as Formula IIC and IIF exist as charged species. Thus, in IIB, the boron-based group is also a Lewis acid and readily complexes with other anions to form IIC. In some cases, a salt, MA, is added to form the anion redox shuttle, where M is a metallic cation and A is selected from the group consisting of F, Cl, Br, and I. For instance, when the compound below

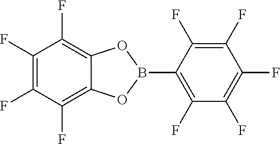 [SMILES: Fc1c(F)c(F)c(B2Oc3c(F)c(F)c(F)c(F)c3O2)c(F)c1F]

is mixed with LiF, a new anion redox shuttle can be formed as

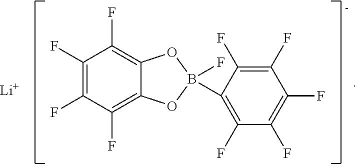

In some embodiments, the redox shuttle has the Formula IB. Representative Y and Z groups are independently selected from the following structures,

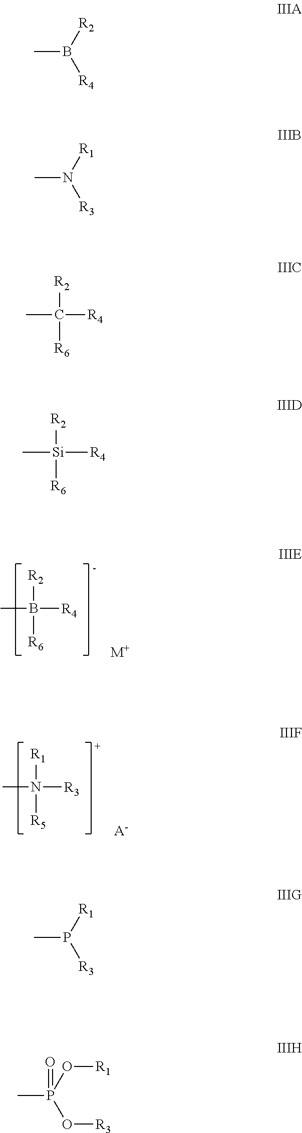

In Formula IIIA-H, each R₁, R₃ and R₅ is independently a hydrogen, an alkyl group, an aryl group, a halogen substituted alkyl group, or a halogen substituted aryl group; each R₂, R₄ and R₆ is independently a halogen atom, an alkyl group, an aryl group, a halogen substituted alkyl group, or a halogen substituted aryl group; M⁺ is a cation; and A⁻ is an anion.

In some embodiments, the redox shuttle is a dimer or oligomer and has the structure:

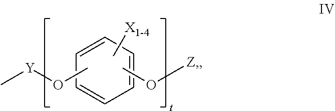

in which t is 2-10.

In still other embodiments, the redox shuttle has the Formula IC. In some embodiments of the Formula IC, the redox shuttle has the structure selected from

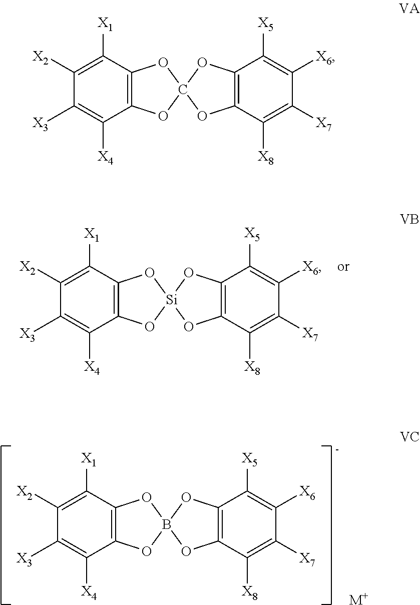

wherein M⁺ is a cation.

Exemplary redox shuttle additives include (tetrafluorobenzo-1,2-dioxyl)-pentafluorophenyl-borane, 1,2-bis(trimethylsiloxyl)tetrafluorobenzene, and mixtures thereof

Inventive electrolytes include a lithium salt dissolved in a polar aprotic solvent. The lithium salt is typically present at a concentration of from about 0.5 to about 2 molar. Representative lithium salt can be a lithium borate cluster salt or at least one mixture of lithium borate cluster salt with other lithium salt like, but not limited to, Li[(C₂O₄)₂B], Li(C₂O₄)BF₂, LiPF₂(C₂O₄)₂, LiPF₄(C₂O₄), LiClO₄, LiBF₄, LiAsF₆, LiPF₆, LiCF₃SO₃, Li(CF₃SO₂)₂N, Li(CF₃SO₂)₃C, LiN(SO₂C₂F₅)₂, lithium alkyl fluorophosphates, or a mixture of any two or more thereof. The lithium borate cluster salt includes Li₂B₁₂X₁₂₋ₙHₙ, Li₂B₁₀X₁₀₋ₙHₙ (X is a halogen and n is an integer) and other boron-based lithium salts yet to be discovered. Lithium(chelato)borates such as Li[(C₂O₄)₂B] and Li(C₂O₄)BF₂, LiPF₂(C₂O₄)₂, LiPF₄(C₂O₄), can also be used as the lithium salt, or as an electrode stabilizing additive. Thus, in some embodiments, the lithium salt is other than a Li[(C₂O₄)₂B] or Li(C₂O₄)BF₂, LiPF₂(C₂O₄)₂, LiPF₄(C₂O₄), and the electrolyte further includes Li[(C₂O₄)₂B] or Li(C₂O₄)BF₂, LiPF₂(C₂O₄)₂, LiPF₄(C₂O₄), at, e.g., about 0.001 to about 10 wt %. As noted below, electrolytes having a blend of anion receptor and Li[(C₂O₄)₂B] or Li(C₂O₄)BF₂ or LiPF₂(C₂O₄)₂, or LiPF₄(C₂O₄), as additives are particularly effective in preventing capacity fade during high temperature storage and cycling.

Suitable polar aprotic solvent include, for example, silane, siloxane, organic phosphate, ethyl acetate, propyl acetate, ethylene carbonate, propylene carbonate, dimethyl carbonate, diethyl carbonate, ethyl methyl carbonate, dimethyl ether, diethyl ether, methyl acetate, gamma butyrolactone, flouro-ether and flouro-ester or a mixture of any two or more thereof. Protic solvents such as water and alcohols can not be used with the present invention.

There are further provided methods of making the non-aqueous electrolytes of the present invention. For example, in some embodiments, the method includes combining a lithium salt; a polar aprotic solvent; and an strong Lewis acid as anion receptor additive at a concentration of 0.0005M to 0.05M. Thus, the anion receptor additive includes compounds of borane, borate, boronate or a mixture of two or more hereof

Electrolytes of the invention may include stabilizing additives that protect the electrodes from degradation. (See e.g., co-pending U.S. application Ser. No. 10/857,365; and provisional application Nos. 60/636,636 and 60/647,361.) Thus, electrolytes of the invention can include electrode stabilizing additive that can be reduced or polymerized on the surface of a negative electrode to form a passivation film on the surface of negative electrode. Likewise, inventive electrolytes can include an electrode stabilizing additive that can be oxidized or polymerized on the surface of the positive electrode to form a passivation film on the surface of the positive electrode. In some embodiments electrolytes of the invention further include mixtures of the two types of electrode stabilizing additives. The additives are typically present at a concentration of about 0.001 to about 10 wt %.

In another aspect, the invention provides an electrochemical device comprising: a cathode; an anode; and an electrolyte as described herein. In one embodiment, the electrochemical device is a lithium secondary battery; the cathode is a lithium metal oxide cathode; the anode is a carbon or lithium metal anode; and the anode and cathode are separated from each other by a porous separator. In such devices the anode may comprise graphite, amorphous carbon, Li₄Ti₅O₁₂, Li₂MTi₆O₁₄ (M=Sr, Ba, or Ca), tin alloys, silicon alloys, intermetallic compounds, lithium metal, or mixtures of any two or more thereof. Suitable graphitic materials including natural graphite, artificial graphite, graphitized meso-carbon microbeads, and graphite fibers, as well as any amorphous carbon materials. Typically, the cathode in such a cell includes spinel, olivine, carbon-coated olivine, LiFePO₄, LiMnPO₄, LiCoO₂, LiNiO₂, LiNi₁₋ₓCo_{y}Met_{z}O₂, LiMn_{0.5}Ni_{0.5}O₂, LiMn_{1/3}CO_{1/3}Ni_{1/3}O₂, LiMn₂O₄, LiFeO₂, LiMet_{0.5}Mn_{1.5}O₄, Li_{1+x′}Ni_{α}Mn_{β}Co_{γ}Met′_{δ}O_{2-z′}F_{z′}, A_{n′}B₂(EO₄)₃ (Nasicon), vanadium oxide, or mixtures of any two or more thereof, wherein Met is Al, Mg, Ti, B, Ga, Si, Mn, or Co; Met′ is Mg, Zn, Al, Ga, B, Zr, or Ti; A is Li, Ag, Cu, Na, Mn, Fe, Co, Ni, Cu, and Zn; B is Ti, V, Cr, Fe, and Zr; E is P, S, Si, W, Mo; 0≦x≦0.3, 0≦y≦0.5, 0≦z≦0.5, 0≦m≦0.5 and 0≦n≦0.5; 0≦x′≦0.4, 0≦α≦1, 0≦β≦1, 0≦γ≦1, 0≦δ≧0.4, and 0≦z′≦0.4; and 0≦n′≦3.

In the electrochemical cells of the present invention, the cathode can include spinel, olivine, or carbon-coated olivine (see Published U.S. Patent Application No. 2004/0157126). For example, the spinel can be a spinel manganese oxide with the formula of Li₁₊ₓMn_{2-z}Met_{y}O₄₋ₘXₙ, wherein Met is Al, Mg, Ti, B, Ga, Si, Ni, or Co; X is S or F; and wherein 0≦x≦0.3, 0≦y≦0.5, 0≦z≦0.5, 0≦m≦0.5 and 0≦n≦0.5. Alternatively, the cathode can comprise olivine with a formula of LiFe_{1-z} Met″_{y}PO₄₋ₘX′ₙ, wherein Met″ is Al, Mg, Ti, B, Ga, Si, Ni, Mn or Co; X′ is S or F; and wherein 0≦x≦0.3; 0≦y≦0.5, 0≦z≦0.5, 0≦m≦0.5 and 0≦n≦0.5.

Cathodes of the present invention may be further stabilized by surface coating the particles of the spinel or olivine with a material that can neutralize acid or otherwise lessen or prevent leaching of the manganese or iron ions. Hence the cathodes can also comprise a surface coating of a metal oxide on the spinel or olivine particles such as ZrO₂, TiO₂, ZnO₂, WO₃, Al₂O₃, MgO, SiO₂, SnO₂ AlPO₄, Al(OH)₃, AlF₃, metal fluorides and metal oxyfourides a mixture of any two or more thereof, or any other suitable metal oxide. The coating can also be applied to a carbon coated olivine. Where carbon coated olivine is used, the metal oxide coating can be applied to the carbon coated olivine or can be applied to the olivine first followed by carbon coating of the metal oxide film. Methods for coating spinel cathodes with metal oxides are disclosed below and may be adapted for use with olivine cathodes.

The metal oxide coating on spinel can be applied using a variety of processes. For example, the coating element source can be dissolved in an organic solvent or water. The coating element sources include metal alkoxide, salt or oxide (e.g., aluminum isopropoxide or magnesium methoxide). Spinel cathode materials are then dispersed in the coating solution. The mixture is stirred until the organic solvent is completely evaporated. If necessary, a flushing gas (CO₂ or moisture-free inert gas) may be used to help facilitate evaporation of the solvent in the coating solution. The dried, coated material is then heat-treated at a temperature ranging from about 100° C. to about 500° C.

A TiO₂ coating can be applied to spinel powders by hydroxylation of tetra-n-butyl titanate (TBT). Thus, for example, the titanate can be reacted with LiOH to precipitate the titanium hydroxide onto the spinel powder. The coated material can be heat-treated at 100 to about 400° C. to yield spinel particles with the desired oxide coating.

A sol-gel process may also be employed in the coating of the spinel. The coating materials including M-ethylhexanatediisopropoxide (M=Zr, Al, Ti, B, Si) and tin ethylhexanoisopropoxide can be dissolved in alcohol (e.g., 2-propanol or isopropanol). The cathode materials are then mixed with the coating solution and annealed at from about 100° C. to about 500° C. Alternatively, a coating solution can be prepared by dissolving ethyl silicate in ethanol and water. Spinel powder is immersed in the coating solution, stirred, dried at 110° C., and then is calcined at from about 200° C. to about 500° C.

The process of coating spinel with AlPO₄ can be carried out by dissolving aluminum nitrate and ammonium phosphate in water until a light white suspension solution (the AlPO₄ nanoparticle solution) is observed. Spinel cathode powder is then added to the coating solution and mixed. The slurry can be dried and annealed at from about 100° C. to about 500° C.

Colloidal suspensions may also be used to coat spinel with metal oxides. For example, the spinel powders can be coated using a 4 wt % (˜0.3 mol %) colloidal ZrO₂ suspension. The spinel particles are immersed and stirred in the ZrO₂ suspension for about 1 h, followed by evaporation of the nascent liquid at 75° C. Thereafter, the products can be heated at about 200 to 400 or 500° C.

Alternatively, the ZrO₂ coating of spinel can be carried out by using two different coating solutions (zirconium oxide+polymeric precursor or an aqueous solution of zirconium nitrate). Spinel could be mixed with the coating solutions until the mixture is dry. Then the mixture could be heated at 100° C. to evaporate the solvents in the coating solutions. The dried mixture could be heat-treated at 200-500° C.

A ZnO₂ coating can be applied to the spinel by dissolving zinc acetate in water, followed by adding the spinel powder, and thoroughly mixing for about 4h at room temperature. After drying, the coated powder is heated at 120° C., and is further calcined at about 200° C. to about 400° C.

Finally, spinel can be coated using a co-precipitation process. Spinel powder is dispersed into a NaHCO₃ solution and ultrasonically agitated. The suspension is then stirred mechanically while Al₂(SO₄)₃ solution is added drop wise to it. In this way, Al(OH)₃ is precipitated onto the spinel particle surface. The final powder is filtered, washed, and dried. The dried powder is heated in air at about 200° C. to about 600° C.

Electrochemical devices employing electrodes comprised of blends of materials are also within the scope of the present invention. For example, the cathode can include a blend of spinel and Li₁₊ₓNi_{α}Mn_{β}Co_{γ}Met′_{δ}O_{2-z}F_{z}, wherein Met′ is Mg, Zn, Al, Ga, B, Zr, or Ti; and wherein 0≦x′≦0.4, 0≦α≦1, 0≦β≦1, 0≦γ≦1, 0≦δ≦0.4, and 0≦z′≦0.4. The ratio of spinel to Li_{i+x′}Ni_{α}Mn_{β}Co_{γ}Met′_{δ}O_{2-z′}F_{z′} is typically from about 0.5 to about 98 wt %. Suitable cathodes can also include a blend of olivine or carbon coated olivine and Li_{1+x′}Ni_{α}Mn_{β}Co_{γ}Met′_{δ}O_{2-z′}F_{z′}, wherein Met′ is Mg, Zn, Al, Ga, B, Zr, or Ti; and wherein 0≦x≦0.4, 0≦α≦1, 0≦β≦1, 0≦γ≦1, 0≦δ≦0.4, and 0≦z≦0.4. As before, the ratio of olivine or carbon-coated olivine to Li_{1+x′}Ni_{α}Mn_{β}Co_{γ}Met′_{δ}O_{2-z′}F_{z′} can be from about 0.5 to about 98 wt %.

The porous separator may be made from materials well known to those skilled in the art. Typically, the porous separator comprises polypropylene, polyethylene, or a multilayer laminate of polypropylene and polyethylene.

The following terms are used throughout as defined below.

Spirocyclic hydrocarbons include ring systems comprising carbon and hydrogen and having two or more rings in which at least two of the rings are joined at a single carbon.

The term “spinel” refers to manganese-based spinel such as, e.g., Li₁₊ₓMn_{2-z}Met_{y}O₄₋ₘXₙ, wherein Met is Al, Mg, Ti, B, Ga, Si, Ni, or Co; X is S or F; and wherein 0≦x≦0.3, 0≦y≦0.5, 0≦z≦0.5, 0≦m≦0.5 and 0≦n≦0.5.

The term “olivine” refers to iron-based olivine such as, e.g., LiFe_{1-z}Met″_{y}PO₄₋ₘX′ₙ, wherein Met″ is Al, Mg, Ti, B, Ga, Si, Ni, Mn or Co; X′ is S or F; and wherein 0≦x≦0.3; 0≦y≦0.5, 0≦z≦0.5, 0≦m≦0.5 and 0≦n≦0.5.

Alkyl groups include straight chain and branched alkyl groups having from 1 to about 20 carbon atoms, and typically from 1 to 12 carbons or, in some embodiments, from 1 to 8 carbon atoms. As employed herein, “alkyl groups” include cycloalkyl groups as defined below. Examples of straight chain alkyl groups include methyl, ethyl, n-propyl, n-butyl, n-pentyl, n-hexyl, n-heptyl, and n-octyl groups. Examples of branched alkyl groups include, but are not limited to, isopropyl, sec-butyl, t-butyl, and isopentyl groups.

Alkylene groups are divalent alkyl groups as defined above, i.e., alkyl groups with two points of attachment within a structure. The attachment points may be on the same or different carbons. Thus, exemplary alkylene groups include —CH₂—, —CH₂CH₂—, —CH(CH₃)₂—, and the like. Halogens include fluorine, chlorine, bromine, and iodine. Typically, anion receptors of the invention are substituted with one or more fluorine or chlorine atoms, but are not so limited.

Cycloalkyl groups are cyclic alkyl groups such as, but not limited to, cyclopropyl, cyclobutyl, cyclopentyl, cyclohexyl, cycloheptyl, and cyclooctyl groups. In some embodiments, the cycloalkyl group has 3 to 8 ring members, whereas in other embodiments the number of ring carbon atoms range from 3 to 5, 6, or 7. Cycloalkyl groups further include polycyclic cycloalkyl groups such as, but not limited to, norbornyl, adamantyl, bornyl, camphenyl, isocamphenyl, and carenyl groups, and fused rings such as, but not limited to, decalinyl, and the like. Cycloalkyl groups also include rings that are substituted with straight or branched chain alkyl groups as defined above. Representative substituted cycloalkyl groups may be mono-substituted or substituted more than once, such as, but not limited to, 2,2-, 2,3-, 2,4- 2,5- or 2,6-disubstituted cyclohexyl groups or mono-, di- or tri-substituted norbornyl or cycloheptyl groups, which may be substituted with, for example, alkyl, alkoxy, amino, thio, hydroxy, cyano, alkoxy, carboxy, carboxamide, oxo, imino, and/or halo groups such as F, Cl, Br, and I groups.

Alkenyl groups are straight chain, branched or cyclic alkyl groups having 2 to about 20 carbon atoms, and further including at least one double bond. In some embodiments alkenyl groups have from 1 to 12 carbons, or, typically, from 1 to 8 carbon atoms. Alkenyl groups include, for instance, vinyl, propenyl, 2-butenyl, 3 butenyl, isobutenyl, cyclohexenyl, cyclopentenyl, cyclohexadienyl, butadienyl, pentadienyl, and hexadienyl groups among others. Alkenyl groups may be substituted similarly to alkyl groups. Divalent alkenyl groups, i.e., alkenyl groups with two points of attachment, include but not limited to CH CH═CH₂, C═CH₂, or C═CHCH₃.

Alkynyl groups are straight chain or branched alkyl groups having 2 to about 20 carbon atoms, and further including at least one triple bond. In some embodiments alkynyl groups have from 1 to 12 carbons, or, typically, from 1 to 8 carbon atoms. Exemplary alkynyl groups include, but are not limited to, ethynyl, propynyl, and butynyl groups. Alkynyl groups may be substituted similarly to alkyl groups. Divalent alkynyl groups, i.e., alkynyl groups with two points of attachment, include but are not limited to CH—C≡H.

Aryl groups are cyclic aromatic hydrocarbons that do not contain heteroatoms. Thus aryl groups include, but are not limited to, phenyl, azulenyl, heptalenyl, biphenylenyl, indacenyl, fluorenyl, phenanthrenyl, triphenylenyl, pyreny;, naphthacenyl, chrysenyl, biphenyl, anthracenyl, and naphthenyl groups. Although the phrase “aryl groups” includes groups containing fused rings, such as fused aromatic-aliphatic ring systems (e.g., indanyl, tetrahydronaphthyl, and the like), it does not include aryl groups that have other groups, such as alkyl or halo groups, bonded to one of the ring members. Rather, groups such as tolyl are referred to as substituted aryl groups. Representative substituted aryl groups may be mono-substituted or substituted more than once, such as, but not limited to, 2-, 3-, 4-, 5-, or 6-substituted phenyl or naphthyl groups, which may be substituted with groups including, but not limited to, amino, alkoxy, alkyl, cyano, and/or halo.

One skilled in the art will readily realize that all ranges discussed can and do necessarily also describe all subranges therein for all purposes and that all such subranges also form part and parcel of this invention. Any listed range can be easily recognized as sufficiently describing and enabling the same range being broken down into at least equal halves, thirds, quarters, fifths, tenths, etc. As a non-limiting example, each range discussed herein can be readily broken down into a lower third, middle third and upper third, etc.

All publications, patent applications, issued patents, and other documents referred to in this specification are herein incorporated by reference as if each individual publication, patent application, issued patent, or other document was specifically and individually indicated to be incorporated by reference in its entirety. Definitions that are contained in text incorporated by reference are excluded to the extent that they contradict definitions in this disclosure.

The present invention, thus generally described, will be understood more readily by reference to the following examples, which are provided by way of illustration and are not intended to be limiting of the present invention.

### EXAMPLES

The synergistic impact of the redox shuttles to boost the overcharge tolerance of lithium-ion cells or batteries was investigated using 2032 type coin cell hardware. The coin cells include a positive electrode, a microporous separator, a negative electrode, and a non-aqueous electrolyte.

### Example 1

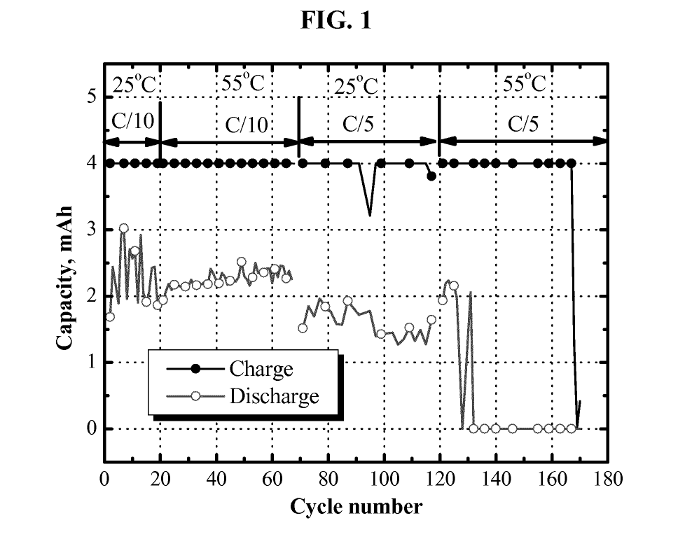

FIG. 1 shows the charge/discharge capacity of a graphite/LiNi_{0.8}Co_{0.15}Al_{0.05}O₂ lithium-ion cell containing 5 wt % 2-(pentafluorophenyl)-tetrafluoro-1,3,2-benzodioxaborole (PFPTFBB) in the electrolyte, which was 1.2 M LiPF₆ in EC/PC/DMC (1:1:3, by weight). The cell was charged and discharged at a constant current of C/10 (0.2 mA). During the charging process, the cell was charged to 4.95 V or until 4.0 mAh charge was delivered (100% overcharge). The cell was initially tested at 25° C. for 20 cycles and was then heated in an oven to 55° C. for another 50 cycles to check the stability of redox shuttle under a more aggressive testing condition. After that, the cell was tested with a higher constant current of C/5. The testing condition for each stage was also labeled in FIG. 1. The redox shuttle mechanism remained active for about 150 cycles.

### Example 2

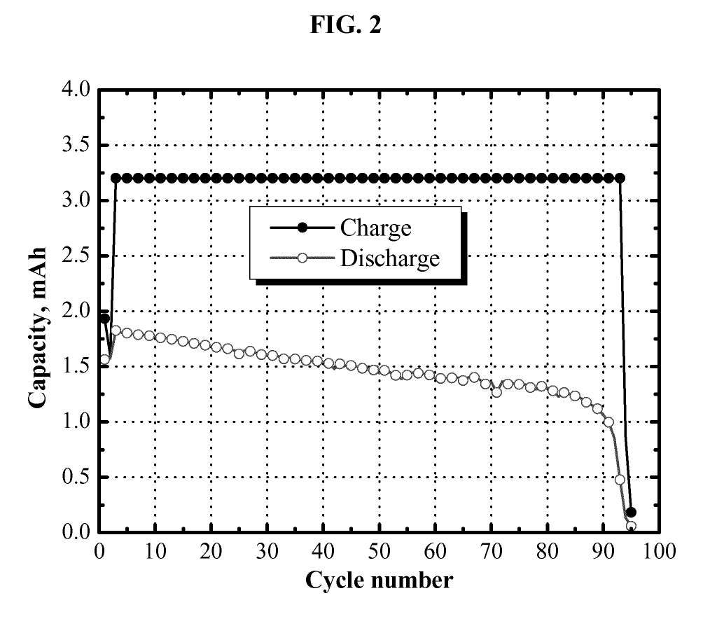

FIG. 2 shows the charge and discharge capacity of a Li_{1.1}[Mn_{1/3}Ni_{1/3}Co_{1/3}]_{0.9}O₂/C lithium ion cell using an electrolyte of 0.4 M Li₂B₁₂F₉H₃ in EC/EMC (3:7, by weight). The cell was tested with a constant current of C/3 (0.5 mA). For each cycle, the cell was charge for 3.2 mAh and the initial discharge capacity of the cell was about 1.5 mAh. It means that the cell was overcharged by about 100% of its reversible capacity each cycle. FIG. 2 shows the overcharge protection mechanism failed after testing for about 90 cycles.

### Example 3

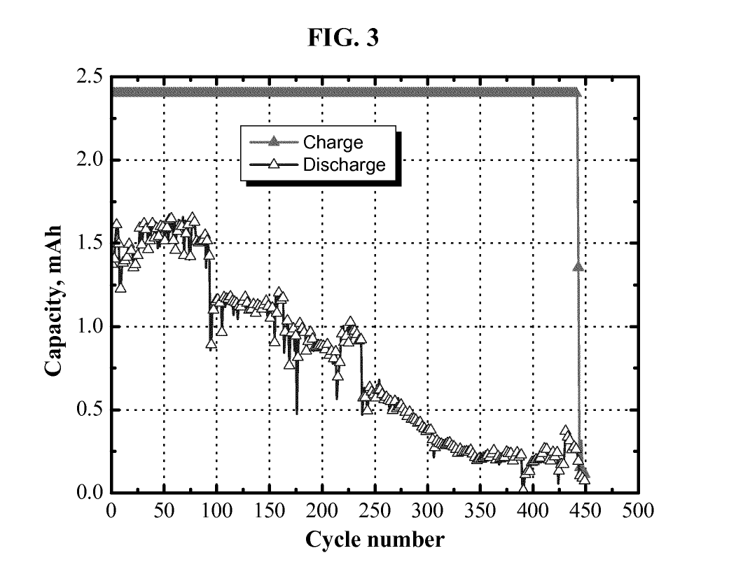

FIG. 3 shows the charge and discharge capacity of a Li_{1.1}[Mn_{1/3}Ni_{1/3}Co_{1/3}]_{0.9}O₂/C lithium ion cell using an electrolyte of 0.4 M Li₂B₁₂F₉H₃ in EC/EMC (3:7, by weight) and using 5.0 wt % PFPTFBB and 1.0 wt % lithium difluoro(oxalato)borate as the electrolyte additive. The overcharge protection mechanism was fully functional up to 450 cycles as shown in FIG. 3. Such cycling longevity is unprecedented. This result was unexpectedly and substantially better than the simple combination of the individual components as shown in Examples 1 (˜160 cycles) and 2 (˜90 cycles).

### EQUIVALENTS

While certain embodiments have been illustrated and described, it should be understood that changes and modifications can be made therein in accordance with ordinary skill in the art without departing from the technology in its broader aspects as defined in the following claims.

The present disclosure is not to be limited in terms of the particular embodiments described in this application. Many modifications and variations can be made without departing from its spirit and scope, as will be apparent to those skilled in the art. Functionally equivalent methods and compositions within the scope of the disclosure, in addition to those enumerated herein, will be apparent to those skilled in the art from the foregoing descriptions. Such modifications and variations are intended to fall within the scope of the appended claims. The present disclosure is to be limited only by the terms of the appended claims, along with the full scope of equivalents to which such claims are entitled. It is to be understood that this disclosure is not limited to particular methods, reagents, compounds compositions or biological systems, which can of course vary. It is also to be understood that the terminology used herein is for the purpose of describing particular embodiments only, and is not intended to be limiting.

In addition, where features or aspects of the disclosure are described in terms of Markush groups, those skilled in the art will recognize that the disclosure is also thereby described in terms of any individual member or subgroup of members of the Markush group.

As will be understood by one skilled in the art, for any and all purposes, particularly in terms of providing a written description, all ranges disclosed herein also encompass any and all possible subranges and combinations of subranges thereof. Any listed range can be easily recognized as sufficiently describing and enabling the same range being broken down into at least equal halves, thirds, quarters, fifths, tenths, etc. As a non-limiting example, each range discussed herein can be readily broken down into a lower third, middle third and upper third, etc. As will also be understood by one skilled in the art all language such as “up to,” “at least,” “greater than,” “less than,” and the like, include the number recited and refer to ranges which can be subsequently broken down into subranges as discussed above. Finally, as will be understood by one skilled in the art, a range includes each individual member.

Other embodiments are set forth in the following claims.

We claim:

1. An electrolyte comprising:
a lithium salt;
a polar aprotic solvent;
a primary redox shuttle; and
a lithium borate cluster salt.

2. The electrolyte of claim 1, wherein the lithium borate cluster salt is a compound of formula U₂B₁₂X₁₂₋ₙHₙ, LiₓX₁₀₋ₙHₙ, or a mixture of two or more thereof, wherein X is F, Cl, Br, or I; and n is an integer ranging from 0 to 12, inclusive.

3. The electrolyte of claim 1 wherein the primary redox shuttle comprises a compound represented by general Formula IA, IB, or IC: 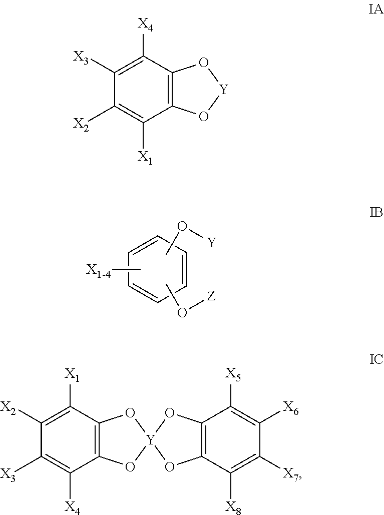
wherein
X₁₋₈ are each independently selected from —H, —F, —Cl, —Br, alkyl, alkoxyl, haloalkyl, —CN, or —NO₂; and
Y and Z are independently a group having a N, B, C, Si, S, or P atom, wherein the N, B, C, Si, S, or P atom is attached to at least one of the two or more oxygen atoms bonded to the aromatic ring.

4. The electrolyte of claim 3 wherein the redox shuttle comprises a compound represented by Formula IA:

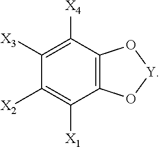

5. The electrolyte of claim 4, wherein the compound represented by Formula IA is a compound of Formula: 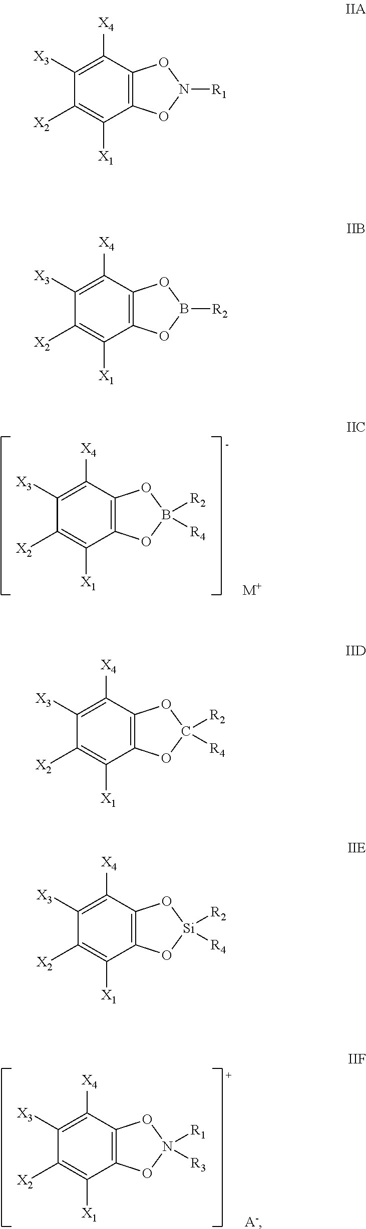 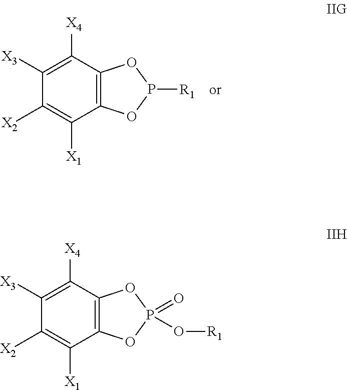
wherein
each R₁ and R₃ is independently H, halogen, an alkyl group, an aryl group, a halogen substituted alkyl group, or a halogen substituted aryl group;
each R₂ and R₄ is independently a halogen atom, an alkyl group, an aryl group, a halogen substituted alkyl group, or a halogen substituted aryl group;
M⁺ is an alkali metal cation; and
A⁻ is an anion.

6. The electrolyte of claim 5, wherein the compound represented by Formula IA is a compound of Formula IIB, each X₁₋₄ is F, Cl, Br, or I; and R₁ is a halogen substituted aryl group.

7. The electrolyte of claim 1, wherein the primary redox shuttle is (tetrafluorobenzo-1,2-dioxyl)-pentafluorophenyl-borane, 1,2-bis(trimethylsiloxyl)tetrafluorobenzene, or a mixture thereof.

8. The electrolyte of claim 2, wherein the primary redox shuttle is (tetrafluorobenzo-1,2-dioxyl)-pentafluorophenyl-borane, 1,2-bis(trimethylsiloxyl)tetrafluorobenzene, or a mixture thereof.

9. The electrolyte of claim 1, wherein the polar aprotic solvent comprises a silane, a siloxane, a organic phosphate, ethylene carbonate, propylene carbonate, dimethyl carbonate, diethyl carbonate, ethyl methyl carbonate, dimethyl ether, or γ-butyrolactone.

10. The electrolyte of claim 1, wherein the lithium salt is Li[B(C₂O₄)₂]; Li[BF₂(C₂O₄)]; LiClO₄; LiBF₄; LiAsF₆; LiSbF₆; LiBr, LiPF₆; LiPF₂(C₂O₄)₂; LiPF₄(C₂O₄); Li[CF₃SO₃]; Li[N(CF₃SO₂)₂]; Li[C(CF₃SO₂)₃]; Li[B(C₆F₅)₄]; Li[B(C₆H₅)₄]; Li[N(SO₂CF₃)₂]; Li[N(SO₂CF₂CF₃)₂]; LiN(SO₂C₂F₅)₂; Li[BF₃C₂F₅]; Li[PF₃(CF₂CF₃)₃]; an lithium alkyl fluorophosphate; or a mixture of any two or more thereof.

11. The electrolyte of claims 1, wherein:
the lithium salt is LiClO₄; LiBF₄; LiAsF₆; LiSbF₆; LiBr, LiPF₆; Li[CF₃SO₃]; Li[N(CF₃SO₂)₂]; Li[C(CF₃SO₂)₃]; Li[B(C₆F₅)₄]; Li[B(C₆H₅)₄]; Li[N(SO₂CF₃)₂]; Li[N(SO₂CF₂CF₃)₂]; LiN(SO₂C₂F₅)₂; Li[BF₃C₂F₅]; Li[PF₃(CF₂CF₃)₃]; an lithium alkyl fluorophosphate; or a mixture of any two or more thereof; and
the electrolyte further comprises about 0.001 to about 8 wt % of Li[(C₂O₄)₂B], Li(C₂O₄)BF₂, LiPF₂(C₂O₄)₂, LiPF₄(C₂O₄), or a mixture of any two or more thereof.

12. The electrolyte of claim 1 further comprising an electrode stabilizing additive that is capable of being reduced or polymerized on the surface of a negative electrode to form a passivation film on the surface of negative electrode.

13. The electrolyte of claim 1 further comprising an electrode stabilizing additive that is capable of being oxidized or polymerized on the surface of positive electrode to form a passivation film on the surface of the positive electrode.

14. The electrolyte of claim 13 further comprising an electrode stabilizing additive that is capable of being reduced or polymerized on the surface of a negative electrode to form a passivation film on the surface of negative electrode.

15. An electrochemical device comprising
a cathode
an anode; and
an electrolyte comprising:
a lithium salt;
a polar aprotic solvent;
a primary redox shuttle; and
a lithium borate cluster salt.

16. The electrochemical device of claim 15, wherein the device is a lithium secondary battery; the cathode is a lithium metal oxide cathode; the anode is a carbon or lithium metal anode; and the anode and cathode are separated from each other by a porous separator.

17. The electrochemical device of claim 15, wherein the cathode comprises spinel, olivine, carbon-coated olivine, LiFePO₄, LiCoO₂, LiNiO₂, LiNi₁₋ₓCo_{y}Met_{z}O₂, LiMn_{0.5}Ni_{0.5}O₂, LiMn_{0.3}Co_{0.3}Ni_{0.3}O₂, LiMn₂O₄, LiMnPO₄, LiFeO₂, LiMet_{0.5}Mn_{1.5}O₄, Li_{1+x′}Ni_{α}Mn_{β}Co_{γ}Met′_{δ}O_{2-z′}F_{z′}, Nasicon, A_{n′}B₂(EO₄)₃, vanadium oxide, or mixtures of any two or more thereof, wherein Met is Al, Mg, Ti, B, Ga, Si, Mn, or Co; Met′ is Mg, Zn, Al, Ga, B, Zr, or Ti; A is Li, Ag, Cu, Na, Mn, Fe, Co, Ni, Cu, and Zn; B is Ti, V, Cr, Fe, and Zr; E is P, S, Si, W, Mo; and 0≦x≦0.3, 0≦y≦0.5, 0≦z≦0.5, 0≦m≦0.5 and 0≦n≦0.5; 0≦x′≦0.4, 0≦α≦1, 0≦β≦1, 0≦γ≦1, 0≦δ≦0.4, and 0z′0.4; and 0≦n′≦3.

18. The electrochemical device of claim 15, wherein the cathode comprises a spinel manganese oxide with a formula of Li₁₊ₓMn_{2-z}Met_{y}O₄₋ₘX′ₙ, wherein Met is Al, Mg, Ti, B, Ga, Si, Ni, or Co; X′ is S or F; and wherein 0≦x≦0.3, 0≦y≦0.5, 0≦z≦0.5, 0≦m≦0.5 and 0≦n≦0.5.

19. The electrochemical device of claim 15, wherein the anode comprises graphite, amorphous carbon, Li₄Ti₅O₁₂, Li₂MTi₆O₁₄, a tin alloy, a silicon alloy, an intermetallic compound, or lithium metal, wherein M is Sr, Ba, or Ca.
